(19) United States
(12) Patent Application Publication
(10) Pub. No.: US 2016/0245104 A1
(43) Pub. Date: Aug. 25, 2016

(54) GAS TURBINE ENGINE AND TURBINE CONFIGURATIONS

(71) Applicant: UNITED TECHNOLOGIES CORPORATION, Farmington, CT (US)

(72) Inventors: Pitchaiah Vijay CHAKKA, Avon, CT (US); Jonathan Jeffery EASTWOOD, Newington, CT (US)

(21) Appl. No.: 14/626,371

(22) Filed: Feb. 19, 2015

(51) Int. Cl. F01D 9/04; F02C 3/14

(52) U.S. Cl. CPC F01D 9/041; F02C 3/14; F05D 2220/32; F05D 2240/12; F05D 2240/35; F05D 2240/80; F05D 2260/20

(57) ABSTRACT

The present disclosure relates to gas turbine engines, and in particular high pressure turbine vane assemblies and combustor/turbine interface configurations. In one embodiment, a vane assembly includes a plurality of turbine vanes, an inner diameter platform, wherein the leading edge of the inner diameter platform is associated with a first axis, and an outer diameter platform, wherein the leading edge of the outer diameter platform is associated with a second axis. The second axis may be offset from the first axis such that the outer platform extends away from the leading edge of turbine vanes greater than the inner platform extends away from the leading edges. Another embodiment is directed to a gas turbine engine include a combustor and a turbine vane assembly, wherein an inner diameter platform and outer diameter platform of the vane assembly interface with the combustor.

### FIELD

The present disclosure relates to gas turbine engines and, in particular, to turbine assemblies and turbine interface configurations for gas turbine engines.

### BACKGROUND

Gas turbine engines are required to operate efficiently during operation and flight. These engines create a tremendous amount of force and generate high levels of heat. As such, components of these engines are subjected to high levels of stress, temperature and pressure. It is necessary to provide components that can withstand the demands of a gas turbine engine. It is also desirable to provide components with increased operating longevity.

Some components of a gas turbine engine experience growth due to the high temperature environment of the engine. By way of example, hot section components of an engine may undergo transformations is size during operation. Uneven temperature distributions across engine parts can reduce the fatigue resistance, operation performance and/or operational life of a component. Accordingly, there is a desire to provide configurations that reduce temperature disparities and overcomes one or more of the aforementioned drawbacks. There is also a desire to improve the configuration of gas turbine engines and vane assemblies.

### BRIEF SUMMARY OF THE EMBODIMENTS

Disclosed and claimed herein are gas turbine engines and high pressure turbine vane assemblies for gas turbine engines. One embodiment is directed to a high pressure turbine vane assembly for a gas turbine engine. The vane assembly includes a plurality of turbine vanes, an inner diameter platform coupled to the base portion of each of the plurality of turbine vanes, wherein the leading edge of the inner diameter platform is associated with a first axis, and an outer diameter platform coupled to the top portion of each of the plurality of turbine vanes. The leading edge of the outer diameter platform is associated with a second axis, the second axis offset from the first axis such that the outer platform extends away from the leading edge of the turbine blades a distance greater than an amount the inner platform extends away from the leading edge of the turbine blades.

In one embodiment, the plurality of turbine blades are configured for a high lift/low foil count high pressure turbine vane assembly.

In one embodiment, a platform length of the outer diameter is greater than 18% of vane pitch.

In one embodiment, the plurality of turbine vanes radially extend between the inner diameter platform and outer diameter platform.

In one embodiment, the outer diameter platform is a circumferentially extending annular structure wherein leading edges of the inner and outer platforms are configured to define, at least in part, an interface between the vane assembly and a combustor.

In one embodiment, the outer diameter platform extends 0.5 inches longer than the inner diameter platform.

In one embodiment, the outer diameter platform extends longer than the inner diameter platform with a range of 0.1 inches longer to 1 inch longer.

In one embodiment, the outer diameter platform is configured to evenly distribute temperature across the outer diameter platform.

In one embodiment, the inner diameter platform and outer diameter platform each extend from the leading edge such that each platform length is at least 18% of vane pitch relative to a respective platform radius.

Another embodiment is directed to a gas turbine engine having combustor and turbine interface configuration. The gas turbine engine includes a combustor extending along a portion of a gas turbine engine and a turbine vane assembly configured to interface with the combustor. The turbine vane assembly includes a plurality of turbine vanes, an inner diameter platform coupled to the base portion of each of the plurality of turbine vanes, wherein the leading edge of the inner diameter platform is associated with a first axis, and an outer diameter platform coupled to the top portion of each of the plurality of turbine vanes. The leading edge of the outer diameter platform is associated with a second axis, the second axis offset from the first axis such that the outer platform extends away from the leading edge of the turbine blades a distance greater than an amount the inner platform extends away from the leading edge of the turbine blades. The inner diameter platform and outer diameter platform interface with the combustor.

In one embodiment, the plurality of turbine blades are configured for a high lift/low foil count high pressure turbine vane assembly.

In one embodiment, a platform length of the outer diameter is greater than 18% of vane pitch.

In one embodiment, the plurality of turbine vanes radially extend between the inner diameter platform and outer diameter platform.

In one embodiment, the outer diameter platform is a circumferentially extending annular structure wherein leading edges of the inner and outer platforms are configured to define, at least in part, an interface between the vane assembly and a combustor.

In one embodiment, the outer diameter platform extends 0.5 inches longer than the inner diameter platform.

In one embodiment, the outer diameter platform extends longer than the inner diameter platform with a range of 0.1 inches longer to 1 inch longer.

In one embodiment, the outer diameter platform is configured to evenly distribute temperature across the outer diameter platform.

In one embodiment, the inner diameter platform and outer diameter platform each extend from the leading edge such that each platform length is at least 18% of vane pitch relative to a respective platform radius.

In one embodiment, the inner diameter platform and outer diameter platform are located immediately downstream of the combustor.

In one embodiment, an interface between the vane assembly and the combustor includes a gas-path passage between a cavity of the combustor and leading edge of the vanes

Other aspects, features, and techniques will be apparent to one skilled in the relevant art in view of the following detailed description of the embodiments.

### BRIEF DESCRIPTION OF THE DRAWINGS

The features, objects, and advantages of the present disclosure will become more apparent from the detailed description set forth below when taken in conjunction with the drawings in which like reference characters identify correspondingly throughout and wherein:

FIG. 1 depicts a cross-sectional representation of a gas turbine engine according to one or more embodiments;

FIG. 2 depicts a graphical representation of a combustor and vane assembly of a gas turbine engine according to one or more embodiments; and

FIGS. 3A-3B depict a vane assembly according to one or more embodiments.

### DETAILED DESCRIPTION OF THE EXEMPLARY EMBODIMENTS

### Overview and Terminology

One aspect of this disclosure relates to configurations for a gas turbine and in particular combustor and vane interface. According to one embodiment a vane assembly and a configuration for a vane assembly are provided. The vane assembly may be configured to allow for an even temperature distribution base one or more features of the assembly including but not limited to than outer diameter platform of the vane assemble. In one embodiment, a vane assembly includes an outer diameter platform that extends beyond the inner diameter platform of the vane assembly, in a forward direction towards a combustor. As will be discussed herein, the configuration of an outer diameter platform can affect the temperature distribution across the vane assembly to allow for an even temperature distribution. By providing an even temperature distribution, component life and/or operational efficiency may be increased.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment,” “certain embodiments,” “an embodiment,” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics may be combined in any suitable manner on one or more embodiments without limitation.

### Exemplary Embodiments

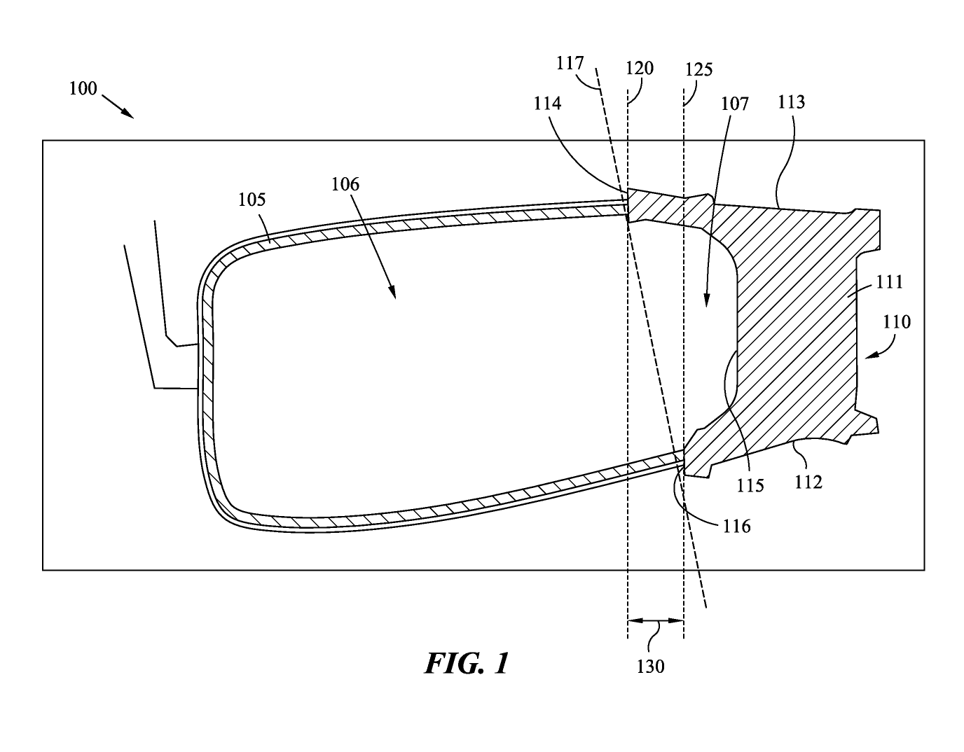

Referring now to the figures, FIG. 1 depicts a cross-sectional representation of a gas turbine engine according to one or more embodiments. Gas turbine engine 100 includes combustor 105 and vane assembly 110. Combustor 105 extends along a portion of a gas turbine engine 100 and provides a gas-flow path from combustor cavity 106 to vane assembly 110. Vane assembly 110 may be a high pressure turbine vane assembly down stream from combustor 105. Vane assembly 110 interfaces with combustor 105 such that the interface between the vane assembly 110 and combustor 105 includes a gas-path passage between a cavity 106 of the combustor and leading edge of vanes of vane assembly 110.

According to one embodiment, vane assembly 110 may include a plurality of turbine vanes, such as vane 111. The leading edge of vane 111 is shown as 115. Vane assembly 110 includes inner diameter platform 112 coupled to the base portion of each vane of vane assembly 110. The leading edge 116 of inner diameter platform 112 is associated with a first axis 125. Outer diameter platform 113 coupled to the top portion of each vane, wherein the leading edge 114 of the outer diameter platform 113 is associated with a second axis 120. Outer diameter platform 113 is a circumferentially extending annular structure wherein leading edges of the inner and outer platforms 113, 112 are configured to define, at least in part, an interface 117 between the vane assembly 110 and combustor 105. Second axis 120 is offset from first axis 125 such that the outer platform 113 extends away from the leading edge 115 of turbine vane 111, and the other vanes of vane assembly 110, a distance 130 greater than an amount the inner platform 112 extends away from the leading edge 115 of turbine 111. First axis 125 and second axis 120 are reference lines that may be tangential or perpendicular to the axis of rotation of the turbine 111.

Inner diameter platform 112 and outer diameter platform 113 are configured to interface with combustor 105. According to one embodiment, interface 117 relates to the intersection of cavity region 107 and vane assembly 110. Outer diameter platform 113 is configured to evenly distribute temperature across the outer diameter platform associated with the interface 117. According to one embodiment, outer diameter platform 113 extends 0.5 inches longer (i.e., longer in an axial direction towards the front of the engine which translates towards the left side of the image in FIG. 1) than the inner diameter platform 112. Outer diameter platform 113 extends longer than the inner diameter platform 112 within a range of 0.1 inches longer to 1 inch. Distance 130 may be provided for length of the outer diameter platform 113 that is greater than 18% of vane 111 pitch. According to one embodiment, vane pitch relates to a ratio of circumference to the number airfoils. For outer diameter platform 113, vane pitch is calculated using the outer diameter of the vane platform at the vane leading edge with respect to a radius of the platform. For inner diameter platform 112, vane pitch is calculated using the inner diameter of the vane platform at the vane leading edge with respect to a radius of the platform.

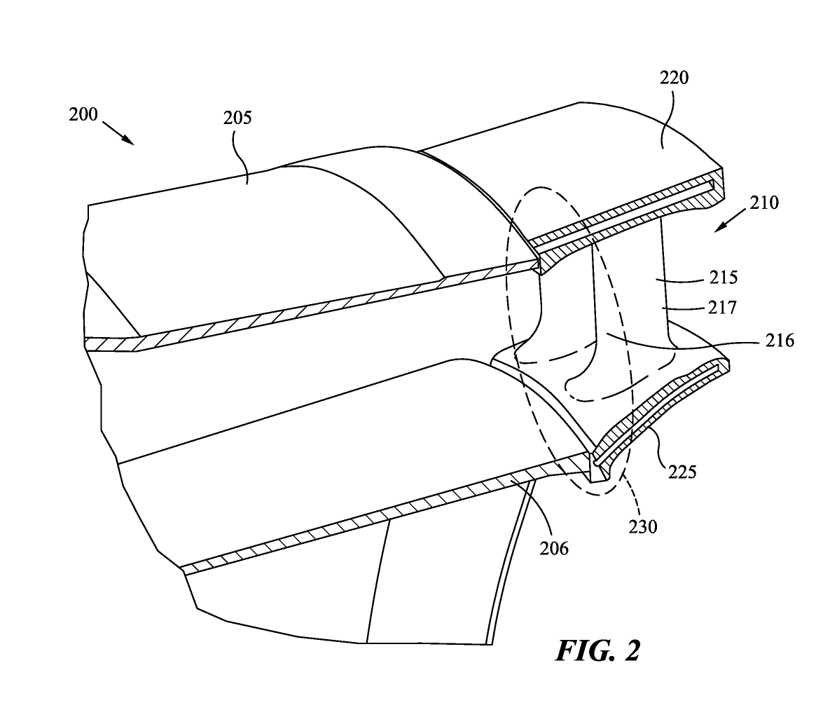

FIG. 2 depicts a graphical representation of a combustor and vane assembly of a gas turbine engine according to one or more embodiments. Combustor 200 is shown as an annular combustor having outer diameter portion 205 and inner diameter portion 206. Combustor 200 interfaces with vane assembly 210 include a plurality of vanes, such as vane 215. According to one embodiment, vane assembly 210 is the first stage of a high pressure turbine. Vane 215 includes leading edge 216 and trailing edge 217. Vane 215 is fit between outer diameter platform 220 and inner diameter platform 225.

An interface between combustor 200 interfaces with vane assembly 210 is shown as 230. According to one embodiment, interface 230 is configured to allow for outer diameter platform 220 to extend further than inner diameter platform 225 towards combustor 200. As such, the temperature distribution in the interface may be evenly distributed.

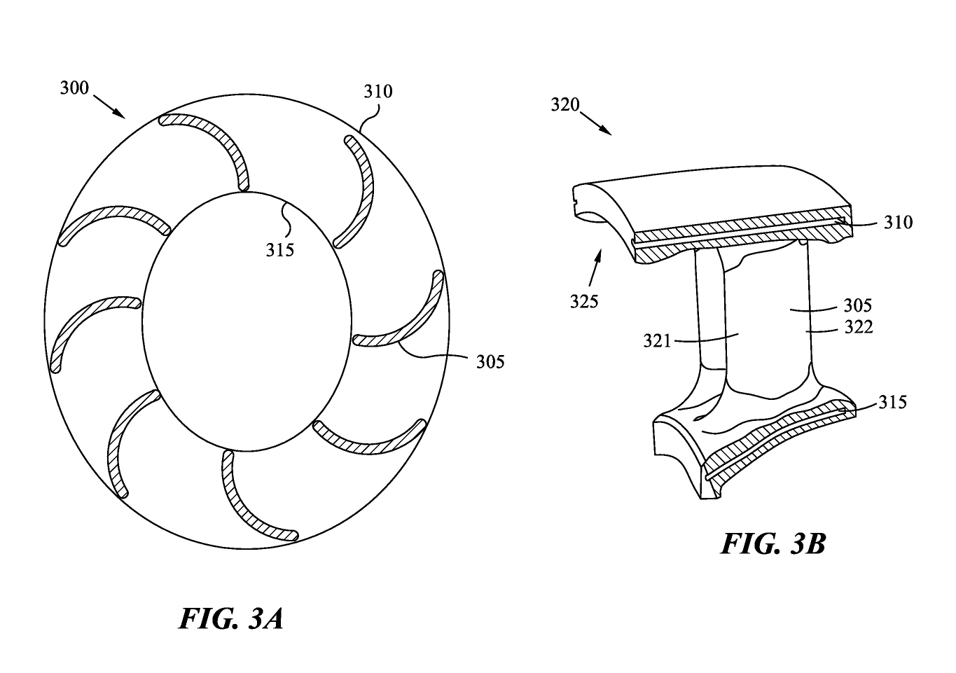

FIGS. 3A-3B depict a vane assembly according to one or more embodiments. FIG. 3A depicts a view of vane assembly 300 according to one or more embodiments. According to one embodiment, vane assembly 300 includes one or more vanes, such as vane 305, an inner diameter platform 315 and outer diameter platform 310. Vane assembly 300 may be a high pressure turbine vane assembly. According to another embodiment, a plurality of turbine vanes of vane assembly 300 are configured for a high lift/low foil count turbine vane assembly. As used herein, a high lift/low foil count turbine vane assembly can relate to a vane assembly of a high pressure turbine assembly aft of the combustor. The plurality of turbine vanes radially extend between the inner diameter platform 315 and outer diameter platform 310.

FIG. 3B depicts a partial representation, shown as 320, of vane assembly 300 for two vanes of the assembly. Vane 305 is shown including leading edge 321 and trailing edge 322. According to one embodiment, diameter platform 310 extends beyond the leading edge of vane 305 as shown by 325. Region 325 relates to a combustor vane assembly interface region.

While this disclosure has been particularly shown and described with references to exemplary embodiments thereof, it will be understood by those skilled in the art that various changes in form and details may be made therein without departing from the scope of the claimed embodiments.

What is claimed is:

1. A high pressure turbine vane assembly for a gas turbine engine, the vane assembly comprising:
a plurality of turbine vanes;
an inner diameter platform coupled to the base portion of each of the plurality of turbine vanes, wherein the leading edge of the inner diameter platform is associated with a first axis; and
an outer diameter platform coupled to the top portion of each of the plurality of turbine vanes, wherein the leading edge of the outer diameter platform is associated with a second axis, the second axis offset from the first axis such that the outer platform extends away from the leading edge of the turbine vanes a distance greater than an amount the inner platform extends away from the leading edge of the turbine vanes.

2. The high pressure turbine vane assembly of claim 1, wherein the plurality of turbine vanes are configured for a high lift/low foil count high pressure turbine vane assembly.

3. The high pressure turbine vane assembly of claim 1, wherein a platform length of the outer diameter is greater than 18% of vane pitch.

4. The high pressure turbine vane assembly of claim 1, wherein the plurality of turbine vanes radially extend between the inner diameter platform and outer diameter platform.

5. The high pressure turbine vane assembly of claim 1, wherein the outer diameter platform is a circumferentially extending annular structure wherein leading edges of the inner and outer platforms are configured to define, at least in part, an interface between the vane assembly and a combustor.

6. The high pressure turbine vane assembly of claim 1, wherein the outer diameter platform extends 0.5 inches longer than the inner diameter platform.

7. The high pressure turbine vane assembly of claim 1, wherein the outer diameter platform extends longer than the inner diameter platform with a range of 0.1 inches longer to 1 inch longer.

8. The high pressure turbine vane assembly of claim 1, wherein the outer diameter platform is configured to evenly distribute temperature across the outer diameter platform.

9. The high pressure turbine vane assembly of claim 1, wherein the inner diameter platform and outer diameter platform each extend from the leading edge such that each platform length is at least 18% of vane pitch relative to a respective platform radius.

10. A gas turbine engine having combustor and turbine interface configuration, the gas turbine engine comprising:
a combustor extending along a portion of a gas turbine engine; and
a turbine vane assembly configured to interface with the combustor, the turbine vane assembly including
a plurality of turbine vanes,
a plurality of turbine vanes,
an inner diameter platform coupled to the base portion of each of the plurality of turbine vanes, wherein the leading edge of the inner diameter platform is associated with a first axis, and
an outer diameter platform coupled to the top portion of each of the plurality of turbine vanes, wherein the leading edge of the outer diameter platform is associated with a second axis, the second axis offset from the first axis such that the outer platform extends away from the leading edge of the turbine vanes a distance greater than an amount the inner platform extends away from the leading edge of the turbine vanes, and
wherein the inner diameter platform and outer diameter platform interface with the combustor.

11. The gas turbine engine of claim 10, wherein the plurality of turbine vanes are configured for a high lift/low foil count high pressure turbine vane assembly.

12. The gas turbine engine of claim 10, wherein a platform length of the outer diameter is greater than 18% of vane pitch.

13. The gas turbine engine of claim 10, wherein the plurality of turbine vanes radially extend between the inner diameter platform and outer diameter platform.

14. The gas turbine engine of claim 10, wherein the outer diameter platform is a circumferentially extending annular structure wherein leading edges of the inner and outer platforms are configured to define, at least in part, an interface between the vane assembly and a combustor.

15. The gas turbine engine of claim 10, wherein the outer diameter platform extends 0.5 inches longer than the inner diameter platform.

16. The gas turbine engine of claim 10, wherein the outer diameter platform extends longer than the inner diameter platform with a range of 0.1 inches longer to 1 inch longer.

17. The gas turbine engine of claim 10, wherein the outer diameter platform is configured to evenly distribute temperature across the outer diameter platform.

18. The gas turbine engine of claim 10, wherein the inner diameter platform and outer diameter platform each extend from the leading edge such that each platform length is at least 18% of vane pitch relative to a respective platform radius.

19. wherein the inner diameter platform and outer diameter platform each extend from the leading edge such that each platform length is at least 18% of vane pitch relative to a respective platform radius.

20. The gas turbine engine of claim 10, wherein the inner diameter platform and outer diameter platform are located immediately downstream of the combustor.

21. The gas turbine engine of claim 10, wherein an interface between the vane assembly and the combustor includes a gas-path passage between a cavity of the combustor and leading edge of the vanes.
